(19) United States
(12) Patent Application Publication
(10) Pub. No.: US 2025/0047722 A1
(43) Pub. Date: Feb. 6, 2025

(54) METHODS FOR HANDLING CHANGE IN AVAILABLE CONNECTION TO PACKET DATA NETWORK IN IP MULTIMEDIA SUBSYSTEMS

(71) Applicant: QUALCOMM Incorporated, San Diego, CA (US)

(72) Inventor: Abhishek SONI, Bangalore (IN)

(21) Appl. No.: 18/365,547

(22) Filed: Aug. 4, 2023

(51) Int. Cl. H04L 65/1016; H04L 65/1045; H04L 65/1073

(52) U.S. Cl. CPC H04L 65/1016; H04L 65/1045; H04L 65/1073

(57) ABSTRACT

Embodiments include methods performed by an Internet protocol (IP) multimedia service (IMS) client in a user equipment for managing a change in connection to a network during an IMS session with a network Various embodiments may include determining whether a second network address for a Proxy Call Session Control Function (PCSCF) is available in response to receiving an indication that a first network address to the PCSCF is no longer available, and attempting to perform an initial registration with the second network address to the PCSCF in response to determining that the second network address is available. Some embodiments may include creating a second network address for the PCSCF, querying the network regarding validity of the second network address, and maintaining the IMS session with the network while requesting a new connection to the network using the second network address to the PCSCF when the second network address is valid.

### BACKGROUND

The IP Multimedia Subsystem (IMS) is a standardized architectural framework designed to deliver IP multimedia services to user equipment (UE) over wireless communication links. IMS uses Internet protocols (IP) as the communication protocol to identify and address datagrams (data packets) to and from computing devices on a communication network, such as a packet data network (PDN). IP version 4 (IPv4) is currently the predominant version of IP used for providing IP services to UEs. IP version 6 (IPv6) is the successor protocol to IPv4 and features a number of improvements. Networks around the world are in the process of upgrading from IPv4 to IPv6, but such upgrades are still underway. Once an IMS session is established using one of two IP versions (i.e., IPv4 or IPv6), that Internet protocol remains fixed for the duration of the IMS session. Mobile UEs establish connections to a network or IMS service via a network element that is known as the Proxy Call Session Control Function (PCSCF), and send and receive IMS data packets to/from either an IPv4 address or an IPV6 address to the PCSCF.

### SUMMARY

Various aspects include systems and methods performed by a processing system of a user equipment (UE) computing device for handling a change in the available connection to a packet data network (PDN) during an IMS communication session. Various aspects may provide a fallback mechanism to enable continuation of the IMS session with little or no interruption when there is a need to switch from IPv6 service to IPv4 service or vice a versa. Various aspects may include determining whether a second network address for a Proxy Call Session Control Function (PCSCF) is available in response to receiving an indication that a first network address to the PCSCF is no longer available, attempting to perform an initial registration with the second network address to the PCSCF in response to determining that the second network address is available, and bringing down the IMS session with the network in response to determining that the second network address is not available.

In some aspects, determining whether a second network address for the PCSCF is available may include creating a second network address for the PCSCF and querying the network whether the second network address for the PCSCF is valid, and attempting to perform an initial registration with the second network address to the PCSCF may include maintaining the IMS session with the network while requesting a new connection to the network using the created second network address to the PCSCF in response to receiving an indication the second network address for the PCSCF is valid.

Some aspects may further include releasing the connection to the network using the first network address to the PCSCF in response to receiving an indication that the new connection to the network, and continuing the IMS session with the network using the second network address for the PCSCF.

Some aspects may further include attempting to establish an IMS connection to a data packet network using a different radio access technology in response to failure of the attempt to perform an initial registration with the second network address to the PCSCF.

In some aspects, the first network address to the PCSCF may be an address for an IP version 6 (IPv6) address to the PCSCF and the second network address to the PCSCF is an IP version 4 (IPv4) address to the PCSCF. In some aspects, the first network address to the PCSCF is an address for an IP version 4 (IPv4) address to the PCSCF and the second network address to the PCSCF is an IP version 6 (IPv6) address to the PCSCF.

Further aspects include a UE having a processing system configured to perform one or more operations of any of the methods summarized above. Further aspects include a processing system for use in a UE configured to perform operations of any of the methods summarized above. Further aspects include a non-transitory processor-readable storage medium having stored thereon processor-executable instructions configured to cause a processing system of a UE to perform operations of any of the methods summarized above. Further aspects include a UE having means for performing functions of any of the methods summarized above.

### BRIEF DESCRIPTION OF THE DRAWINGS

FIG. 1 is a system block diagram illustrating an example communications system suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4 is a component block diagram illustrating a system configured for managing QoS packet filter rules accordance with various embodiments.

FIG. 5A is a process flow diagram illustrating an example method 500a for managing a change in an IMS connection to a network that may be performed by a UE processing system executing an IMS client in accordance with various embodiments.

FIGS. 5B-5D are process flow diagrams illustrating further operations that may be performed as part of the method illustrated in FIG. 5A according to some embodiments.

FIGS. 6A-6D are message flow diagrams illustrating examples of signals that may be exchanged between an IMS of UE and a network according to various embodiments and under different circumstances.

FIG. 7 is a component block diagram of a UE suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include systems and methods for handling a change in the available connection (i.e., an IPV6 or IPv4 type IP link) to a network during an IMS session by providing a fallback mechanism to attempt service on the other type of IP IMS link if available. Various embodiments may enable continuation of the IMS session with little or no interruption when there is a need to switch from IPV6 service to IPv4 service or vice a versa. Various embodiments may include determining whether a second network address for a Proxy Call Session Control Function (PCSCF) in the network is available in response to receiving an indication that a first network address on which the IMS session is occurring is no longer available. In circumstances in which the UE requested and the PCSCF initially offered both types of IP version connections (i.e., both IPV6 and IPv4 addresses to the PCSCF), the UE may attempt to perform an initial registration using the other type of IP version connection (i.e., IPv4 if the current session was using IPV6, and vice versa). When successful, various embodiments may avoid interruptions to the IMS session as well as the additional signaling required to tear down and then after a delay attempt to reestablish an IMS session with the same network.

The term “UE” is used herein to refer to any one or all of cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, wireless router devices, industrial manufacturing equipment, large and small machinery and appliances for home or enterprise use, wireless communication elements within vehicles, wireless devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement global system for mobile communications (GSM) Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

The IP Multimedia Subsystem (IMS) is a standardized architectural framework designed to deliver IP multimedia services. Traditionally, mobile phones have provided voice call services over a circuit-switched-style network, rather than strictly over an IP packet-switched network. IMS was designed by the wireless standards body 3rd Generation Partnership Project (3GPP), with the vision of evolving mobile networks beyond circuit-switched-style networks. The user equipment (UE) can connect to IMS in various ways, most of which use the standard Internet protocol (IP) connecting to a packet data network (PDN) Gateway through what is known as the SGi interface.

A Proxy Call Session Control Function (PCSCF) is an edge access function in networks that support IMS. The PCSCF provides a UE in a mobile communication network with the first point of contact to the network for IMS traffic. All IMS traffic goes through the PCSCF, which acts as the ingress and egress point to and from a service provider's IMS domain with respect to the IMS client.

IPv4 and IPV6 are the two versions of the Internet Protocol that are widely used. IPv4 uses a 32-bit address for its Internet addresses, which means it can provide support for approximately 4.29 billion IP addresses. The IPV6 is the next generation Internet Protocol address standard intended to supplement and eventually replace IPv4. IPv6 functions similarly to IPv4 in that it provides the unique IP addresses necessary for Internet-enabled devices to communicate. However, it utilizes a 128-bit IP address, significantly expanding the number of possible addresses. While IPv6 has many advantages, its deployment in networks around the world is not complete. Thus, there are many locations where IPv6 service may not be available, in which case an IMS session will need to use the IPV4 protocol.

A UE establishes an IPV4 or IPv6 session with the P-CSCF to establish an IMS session in various ways, most of which use the standard Internet protocol. IMS UE terminals, such as mobile phones, personal digital assistants (PDAs), and computers, can register directly on IMS, even when roaming in another network or country. The only requirement is that the UE use IP and run Session Initiation Protocol (SIP) user agents. The PCSCF is assigned to an IMS terminal in the UE before registration, and does not change for the duration of the IMS session.

However, a problem can arise when an IMS session established with either an IPV4 or IPv6 protocol link is no longer available. The UE may be notified of this by receiving a modify bearer request with a Null PCSCF over any IP. In this case, the IMS session cannot continue because the previously established type of IP link is not available on the network for some reason, and thus the corresponding address for the PCSCF is no longer valid. The conventional method for responding to such an interruption in the current link protocol or unavailability of the PCSCF it is to tear down the communication link to the network, wait a period of time, such as 10 or 12 minutes, and then attempted to reestablish a connection to the network via the PCSCF. This necessarily interrupts the IMS service for the period of time even if a reconnection to the network as possible, such as on the other type of Internet protocol link. This will impact the user experience, as well as add the burden of additional communication exchanges with the network required to reestablish a connection to the network after the waiting period.

There are any number of reasons why an IMS session with the network may be interrupted by the current IP link (i.e., IPv4 or IPv6) of the session is no longer available. Not all networks that support IMS services support both IPv4 and IPV6. Many networks have not been upgraded yet and thus are still using IPv4. Consequently, it is possible that a mobile UE (e.g., in an automobile) may initially establish an IMS communication link with the network that uses IPV6, but then travel into the coverage of a network that only supports IPv4. Upon entering such network, the UE will receive a modify bearer request with a Null P-CSCF, and be required to establish a new network connection using IPv4. Other situations can arise when a network that supports both types of IP links includes regions where wireless signals associated with one type of IP link (i.e., IPv4 or IPv6) are received better that signals of the other type of IP link, and the UE moves through one of those regions. Further situations may arise when there is an equipment failure within a network that causes an outage of one IP link but not the other. Other causes are also possible.

Various embodiments include methods and wireless devices configured to perform the methods that may enable continuing and IMS communication session when a current Internet protocol type link of the ongoing IMS session is no longer available by providing a fallback procedure use the other type of Internet protocol link when available. In various embodiments, a processing system of a UE may determine whether a second network address for the PCSCF is available in response to receiving an indication that the current network address to the PCSCF is no longer available. As noted, this indication may be in the form of a modify bearer request with a Null P-CSCF. In some embodiments, the processing system may make this determination based on information that is stored in memory or otherwise known based upon the initial communications with the PCSCF. For example, if the UE requested either or both IPv4 and IPV6 links and the PCSCF responded with PCSCF addresses for establishing an IMS session, this information may be known to the processing system, such as an address stored in memory, indicated as a flag set in a register, or other mechanism for keeping track of the alternative IP link address to the PCSCF that the processing system can access to make this determination. If the processing system determines that there is an alternative IP link address to the PCSCF, the processing system may attempt to perform an initial registration using the alternative IP link type address to the PCSCF (also referred to as the “second network address to the PCSCF”). If not, the processing system may perform the conventional operations in response to such notice, including tearing down the communication link to the network, and waiting a period of time (e.g., 10 or 12 minutes) before attempting to reestablish a link to the network via the PCSCF.

In some embodiments, the process of attempting to perform it an initial registration with the network using the other IP link address to the PCSCF may include creating a second network address for the PCSCF and inquiring of the network, such as via emotive data surface of the, determine whether that created second address is valid. This may involve sending a query to the network and determining validity based upon the received query response. With the network (or modem date service) indicates that the address is valid, the UE processing system may request a new connection to the network using that address to the PCSCF and continue the IMS session using the new connection. However, if the created second network address is not valid, the processing system may perform the conventional operations, tearing down the communication link to the network, and waiting a period of time before attempting to reestablish a link to the network via the PCSCF.

Various embodiments may improve the operation of a UE engaged in an IMS communication session with a network by enabling the UE to fall back to an alternative Internet protocol version in response to a change in available IP of the network to continue the IMS session instead of interrupting the communication session as is currently required in such circumstances. Various embodiments may also reduce the amount of communication overhead associated with reestablishing an IMS connection to a network under such circumstances.

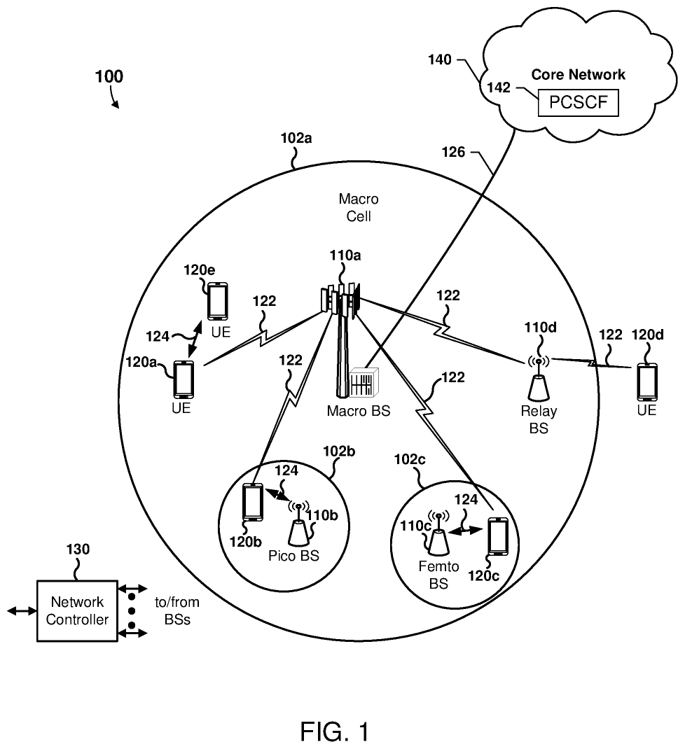

FIG. 1 is a system block diagram illustrating an example communications system 100 suitable for implementing any of the various embodiments. The communications system 100 may be a 5G New Radio (NR) network, or any other suitable network such as a Long Term Evolution (LTE) network. While FIG. 1 illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of wireless devices (illustrated as wireless devices 120a-120e in FIG. 1). The communications system 100 also may include a number of base stations (illustrated as the BS 110a, the BS 110b, the BS 110c, and the BS 110d) and other network entities. A base station is an entity that communicates with wireless devices, and also may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used. The core network 140 may be any type core network, such as an LTE core network (e.g., an EPC network), 5G core network, etc.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network.

The base station 110a-110d may communicate with the core network 140 over a wired or wireless communication link 126. The wireless device 120a-120e may communicate with the base station 110a-110d over a wireless communication link 122.

The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay BS 110d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, user equipment (UE), etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per wireless device. Multi-layer transmissions with up to 2 streams per wireless device may be supported.

Aggregation of multiple cells may be supported with up to eight serving cells. Alternatively, NR may support a different air interface, other than an OFDM-based air interface.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network. Additionally, wireless devices 120a-120e may also communicate with other wireless networks using further RATs, such as Wi-Fi that may connect with an access point, which may also be hosed on a base station 110a-110d.

In some implementations, two or more wireless devices 120a-120e (for example, illustrated as the wireless device 120a and the wireless device 120e) may communicate directly using one or more sidelink channels 124 (for example, without using a base station 110a-110d as an intermediary to communicate with one another). For example, the wireless devices 120a-120e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 120a-120e may perform scheduling operations, resource selection operations, as well as other operations described elsewhere herein as being performed by the base station 110a-110d.

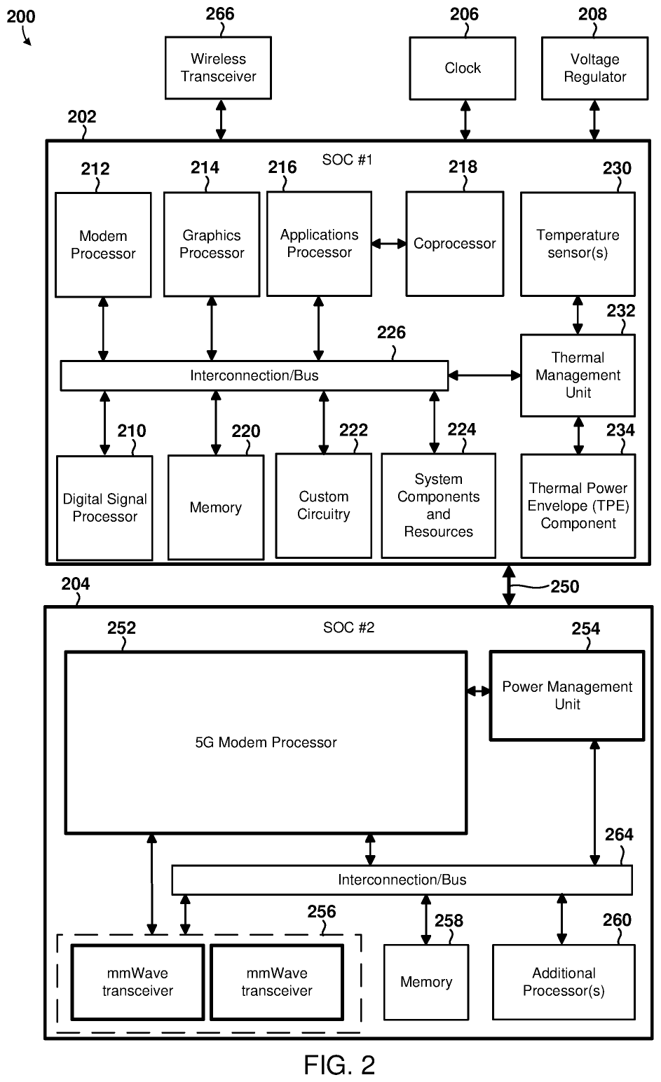

FIG. 2 is a component block diagram illustrating an example processing system and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1 and 2, a processing system 202 may be implemented with a bus architecture, represented generally by the bus 226, 264. The bus 226, 264 may include any number of interconnecting buses and bridges depending on the specific application of the processing system 202 and the overall design constraints. The bus 226, 264 links together various circuits including one or more processors 210, 212, 214, 216, 218, 252 and/or hardware components 222, 224, 230, 232, 234. The processors 210, 212, 214, 216, 218, 252 may include multiple processor cores. The memory 220 may include multiple memories. The bus 226, 264 may also link various other circuits, such as a clock controller 206, interface circuitry voltage regulators 208, and/or power management circuits 234, 254.

The illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from a wireless device (e.g., 120a-120e) or a base station (e.g., 110a-110d). In some implementations, the first SOC 202 may operate as central processing unit (CPU) of the wireless device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), and/or very high frequency short wavelength (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 also may include circuitry to interface with peripheral devices, such as cameras, electronic displays, wireless communication devices, external memory chips, etc.

The first and second SOC 202, 204 may communicate via an interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

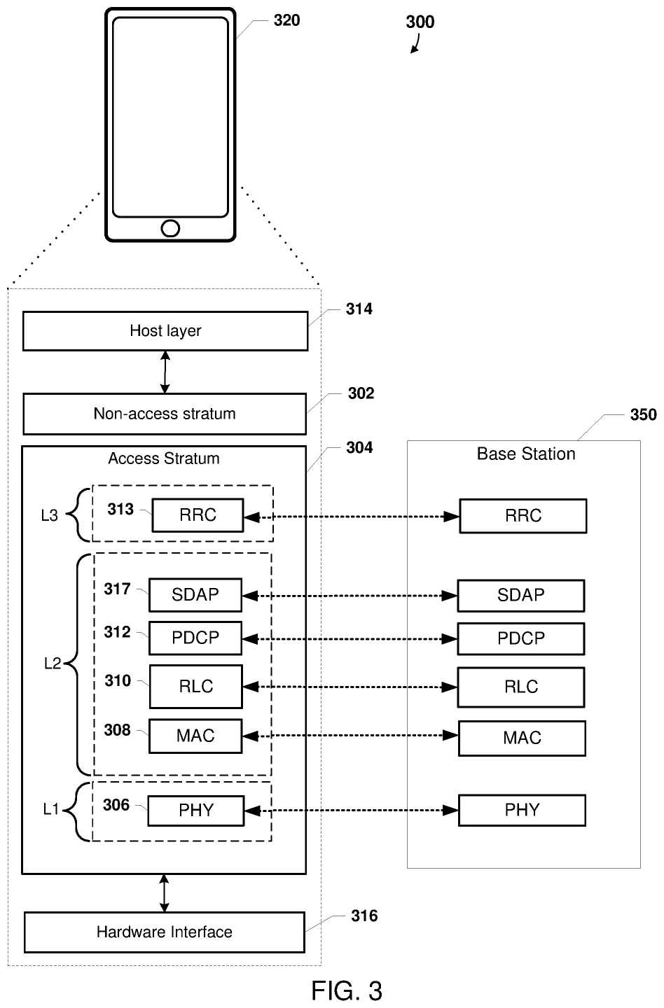

FIG. 3 is a component block diagram illustrating a software architecture 300 including a radio protocol stack for the user and control planes in wireless communications suitable for implementing any of the various embodiments. With reference to FIGS. 1-3, the wireless device 320 may implement the software architecture 300 to facilitate communication between a wireless device 320 (e.g., the wireless device 120a-120e, 200) and the base station 350 (e.g., the base station 110a-110d) of a communication system (e.g., 100). In various embodiments, layers in software architecture 300 may form logical connections with corresponding layers in software of the base station 350. The software architecture 300 may be distributed among one or more processors (e.g., the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (such as SIM(s) 204) and its core network 140. The AS 304 may include functions and protocols that support communication between a SIM(s) (such as SIM(s) 204) and entities of supported access networks (such as a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In some implementations, Layer 2 may include a media access control (MAC) sublayer 308, a radio link control (RLC) sublayer 310, and a packet data convergence protocol (PDCP) 312 sublayer, and a Service Data Adaptation Protocol (SDAP) 317 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the wireless device 320 and the base station 350.

In various embodiments, the SDAP sublayer 317 may provide mapping between Quality of Service (QOS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some implementations, application-specific functions provided by the at least one host layer 314 may provide an interface between the software architecture and the general purpose processor 206.

In other implementations, the software architecture 300 may include one or more higher logical layer (such as transport, session, presentation, application, etc.) that provide host layer functions. For example, in some implementations, the software architecture 300 may include a network layer (such as Internet Protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

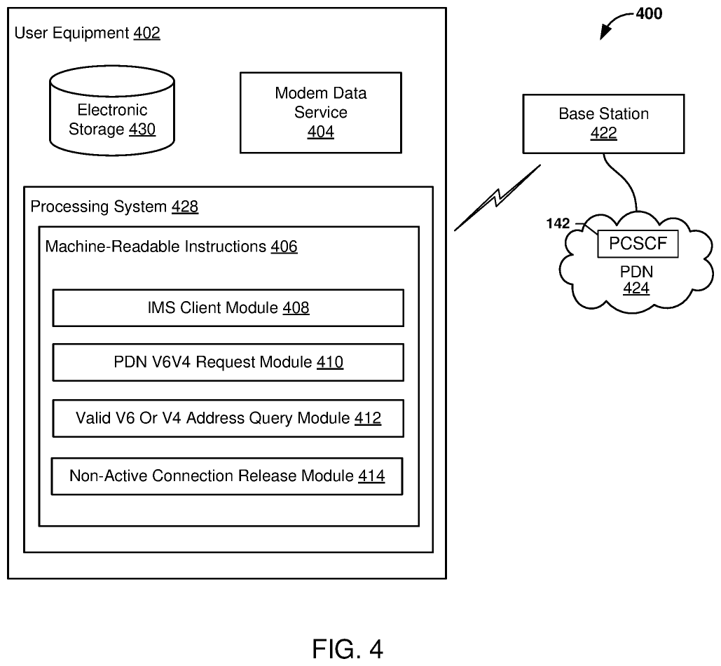

FIG. 4 is a component block diagram illustrating a system 400 configured for managing QoS packet filter rules in accordance with various embodiments. With reference to FIGS. 1-4, system 400 may include a UE 402 (e.g., 120a-120e) and a base station 422 (e.g., 110a-110d).

The UE 402 and the base station 422 may include a processing system 428 including one or more processors coupled to electronic storage 430 and a modem data service 404 and a wireless transceiver (e.g., 266). In the UE 402 and the base station 422, the modem data service 404 may be configured to receive messages sent in transmissions and pass such message to the processing system 428 for processing. Similarly, the processor 428 may be configured to send messages for transmission to the wireless transceiver 266 for transmission.

Referring to the UE 402, the processing system 428 may be configured by machine-readable instructions 406. Machine-readable instructions 406 may include one or more instruction modules. The instruction modules may include computer program modules. The instruction modules may include one or more of an IMS client module 408, a PDN V6V4 Request module 410, a Non-active Connection Release module 414, and//or other instruction modules.

The IMS client module 408 may be configured to provide the IMS functionality for exchanging data packets via IPv6 or IPv4 communication links with a PDN communication network including performing some of the operations of various embodiments.

The PDN V6V4 Request module 410 may be configured to communicate via the modem data service 404 with the PCSCF 142 of the PDN 424 to request a IPv6 and/or IPv4 communication link. In some cases, the PDN V6V4 Request module 410 may request from the PCSCF 142 information for connecting via both IPV6 and IPv4 when the UE is capable of supporting both types of IP links.

The Non-active Connection Release module 414 may be configured to release a communication link that is not used. For example, if the UE has received information for both IPv6 and IPv4 connections and established an IPV6 connection with the PCSCF 142, the Non-active Connection Release module 414 may release the IPV4 connection.

In some embodiments, the UE 402 and the base station 422 may be operatively linked via one or more electronic communication links (e.g., wireless communication link 122, 124, 126). It will be appreciated that this is not intended to be limiting, and that the scope of this disclosure includes embodiments in which the UE 402 and the base station 422 may be operatively linked via some other communication medium.

The electronic storage 430 may include non-transitory storage media that electronically stores information. The electronic storage media of electronic storage 430 may include one or both of system storage that is provided integrally (i.e., substantially non-removable) with the UE 402 and the base station 422 and/or removable storage that is removably connectable to the UE 402 and the base station 422 via, for example, a port (e.g., a universal serial bus (USB) port, a firewire port, etc.) or a drive (e.g., a disk drive, etc.). Electronic storage 430 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 430 may include one or more virtual storage resources (e.g., cloud storage, a virtual private network, and/or other virtual storage resources). Electronic storage 430 may store software algorithms, information determined by processing system 428, information received from the UE 402 and the base station 422, or other information that enables the UE 402 and the base station 422 to function as described herein.

The processing system 428 may be configured to provide information processing capabilities in the UE 402 and the base station 422. As such, the processing system 428 may include one or more of a digital processor, an analog processor, a digital circuit designed to process information, an analog circuit designed to process information, a state machine, and/or other mechanisms for electronically processing information. Although the processing system 428 are illustrated as single entities, this is for illustrative purposes only. In some embodiments, the processing system 428 may include a plurality of processing units and/or processor cores. The processing units may be physically located within the same device, or processing system 428 may represent processing functionality of a plurality of devices operating in coordination. The processing system 428 may be configured to execute modules 408-414 and/or other modules by software; hardware; firmware; some combination of software, hardware, and/or firmware; and/or other mechanisms for configuring processing capabilities on processing system 428. As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules 408-414 is for illustrative purposes, and is not intended to be limiting, as any of modules 408-414 may provide more or less functionality than is described. For example, one or more of the modules 408-414 may be eliminated, and some or all of its functionality may be provided by other modules 408-414. As another example, the processing system 428 may be configured to execute one or more additional modules that may perform some or all of the functionality attributed below to one of the modules 408-414.

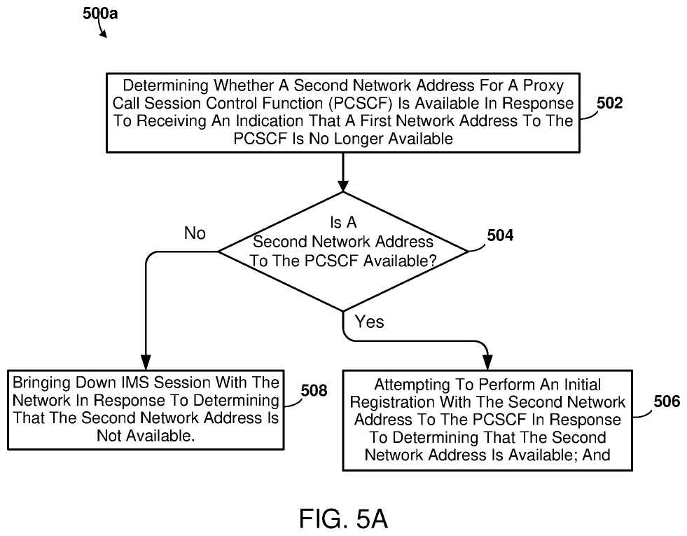

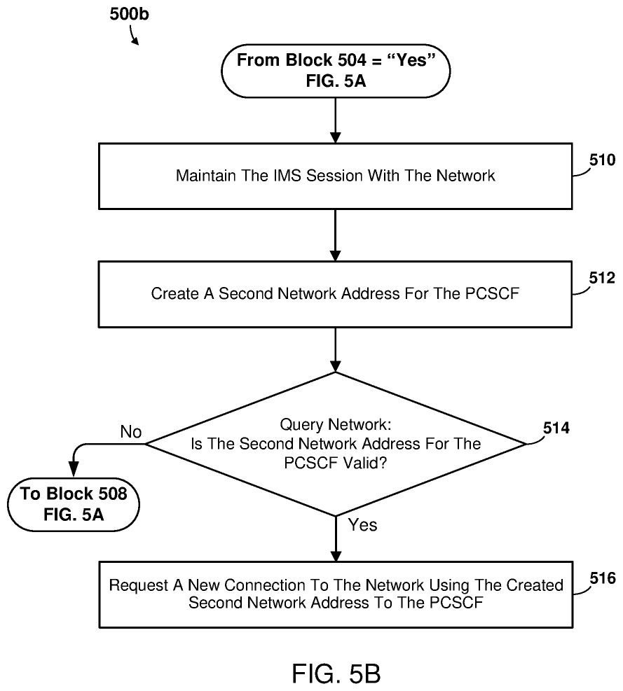

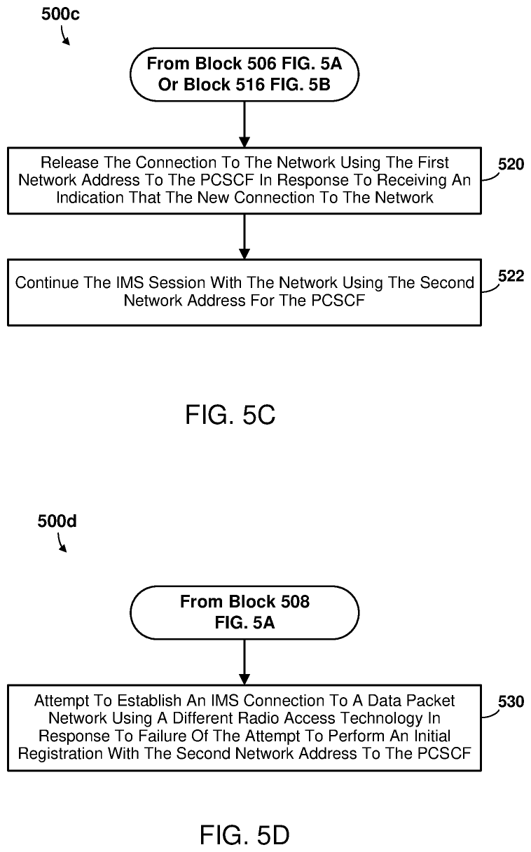

FIG. 5A is a process flow diagram illustrating an example method 500a for managing a change in an IMS connection to a network (e.g., a PDN) that may be performed by a UE processing system executing an IMS client in accordance with various embodiments. With reference to FIGS. 1-5A, means for performing operations of the method 500a may include a processing system as described herein. A processing system may include one or more processors (e.g., 202, 212, 216, 218, 252, 428) of a UE (e.g., 120a-120e, 320, 402, 700), a modem coupled to a wireless transceiver (e.g., 266) providing a modem data service (e.g., 212, 252, 404), and/or hardware elements, any one or combination of which may be configured to perform any of the operations of the method 500a. Further, one or more processors within a processing system may be configured with software or firmware to perform various operations of the method. To encompass any of the processors, hardware elements and software elements that may be involved in performing the method 500a, the elements performing method operations are referred to generally as a “processing system.”

The method 500 may be performed after the UE has established an IMS session with the network (e.g., a PDN) via the PCSCF. As described, the UE and the PCSCF will have already exchanged messages requesting and the UE will have received an IPV4 address and/or an IPV6 address to the PCSCF depending on the type of IMS services available on the network. Using the IPV4 or IPv6 address that corresponds to a setting or preference in the UE, the UE and the PCSCF will have completed the handshaking to establish the IMS session and begun exchanging packets via the IMS service.

During the IMS session with the network the UE may receive a message or indication, such as from the PCSCF, that the current network address to the PCSCF is no longer supported. For example, if communications are being exchanged under IPv6, the UE may receive a message indicating that the IPV6 address is no longer supported or valid. This may be in the form of an IPV6 NULL message. A similar notification may be received if communications are being exchanged under IPv4 and IPv4 is no longer supported (i.e., an IPV4 NULL message). As described, this may occur for a variety of reasons in various wireless networks. To address this occasional situation, the method 500 provides for a “fall back” option that may enable continuing the IMS service session with the PDN under certain circumstances, thus avoiding the need to tear down the connection and wait (e.g., 10-12 minutes) before attempting to reestablish an IMS session with the network.

In response to receiving a message or indication that a first network address to the PCSCF (e.g., for IPV6 or IPv4 service) is no longer available, such as receiving an IPV6 NULL message or an IPV4 NULL message, the processing system may determine whether a second network address (e.g., for IPV4 or IPv6 service) for the PCSCF is available in block 502 and determination block 504. For example, if the UE is capable of either IPv4 or IPv6 service and requested either or both types of service in handshaking messages with the PCSCF and received addresses for both IPv4 and IPV6 connections to the PCSCF, the processing system may determine in block 502 that addresses for both types of IMS service were received (e.g., by checking a memory or flag). Based on this the processing system may conclude that the type of IP service connection not in use may still be available, and thus determine that the second network address to the PCSCF is available (i.e., determination block 504=“Yes”). However, if the UE only requested one type of IP service or only received a network address to the PCSCF for one type of IP service, the processing system may determine in block 502 that a second network address to the PCSCF is not available (i.e., determination block 504=“No”). Means for performing the operations of block 502 include the processing system executing the IMS client module 408.

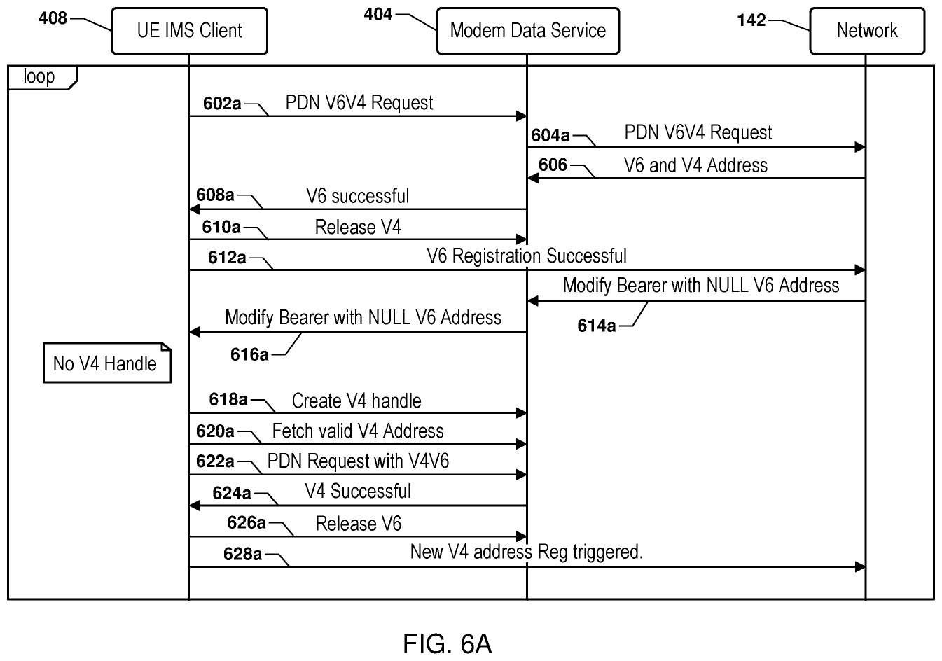

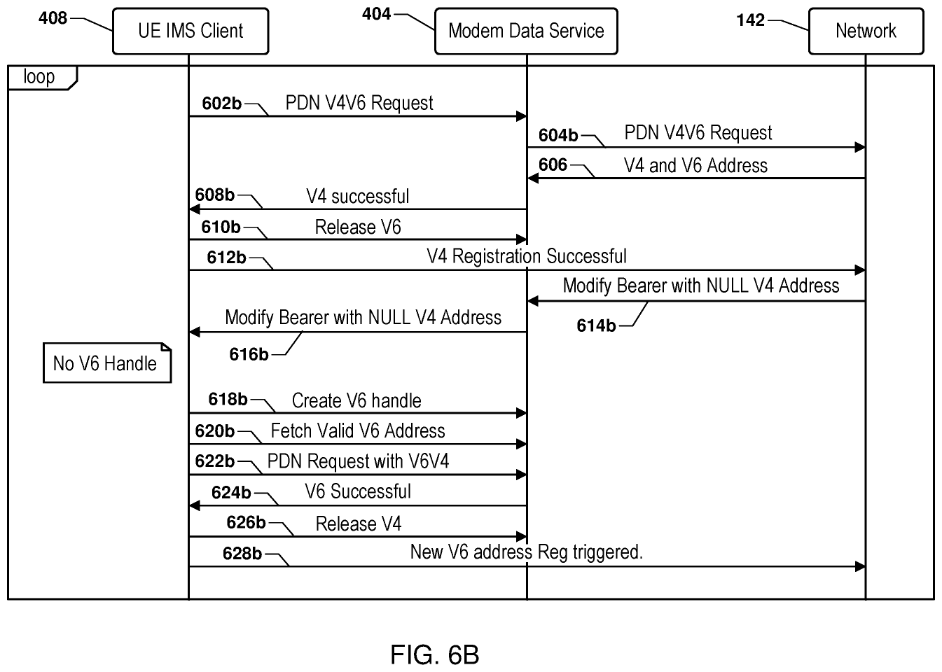

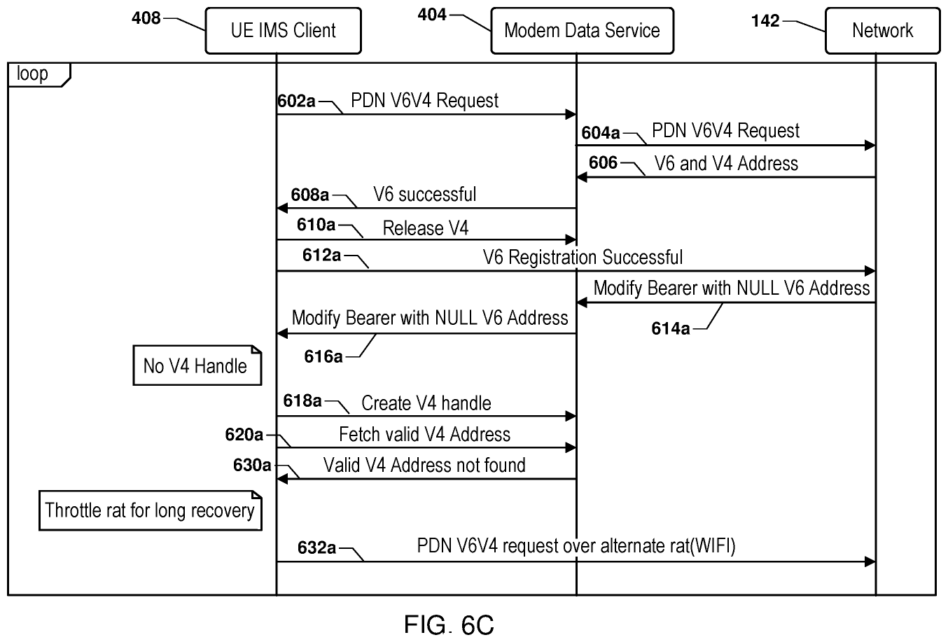

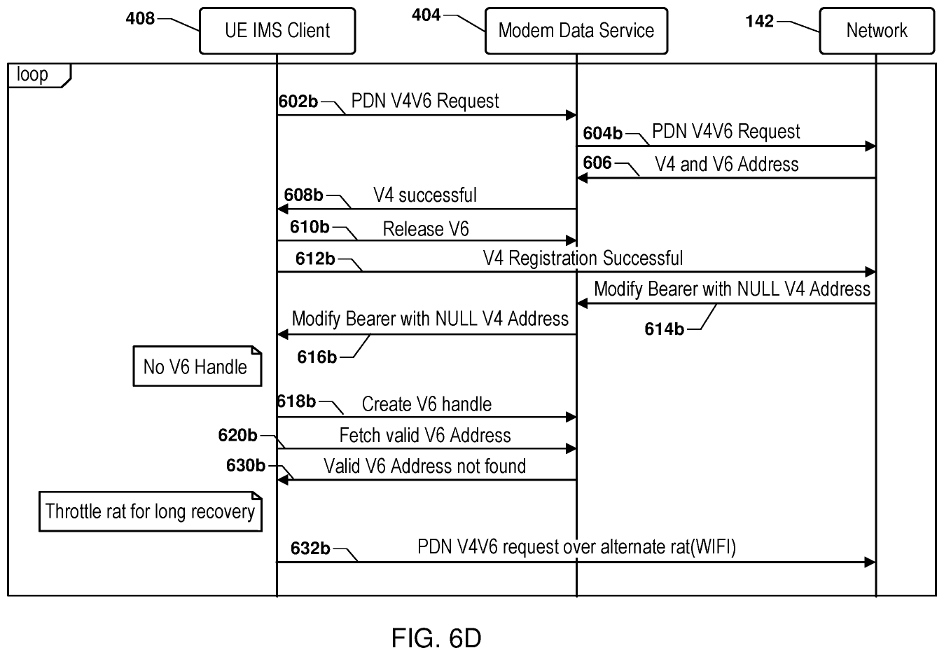

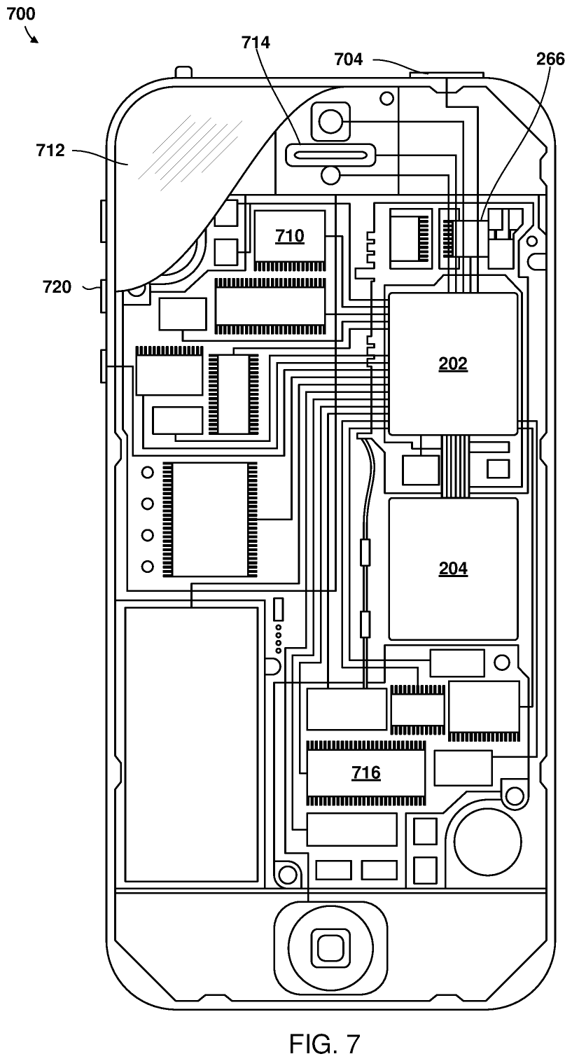

In response to determining that the second network address to the PCSCF is available (i.e., determination block 504=“Yes”), the processing system may attempt to perform an initial registration with the second network address to the PCSCF in block 506. Operations that may be performed in block 504 are described in more detail with reference to FIGS. 5B and 6A-6D. Means for performing the operations of block 506 include the processing system (e.g., 202, 212, 216, 218, 252, 428) executing the IMS client module 408 and PDN V6V4 Request module 410, and the modem data service 404.

In response to determining that a second network address to the PCSCF is not available (i.e., determination block 504=“No”), the processing system may bring down the IMS session with the network and may perform a convention attempt to recover service in block 508. As noted, conventional methods of reestablishing an IMS session with a network may include waiting 10 to 12 minutes before attempting to contact the PCSCF in the network to negotiate a new session by repeating the signaling necessary to establish a brand new IMS connection. Means for performing the operations of block 508 include the processing system (e.g., 202, 212, 216, 218, 252, 428) executing the IMS client module 408 and PDN V6V4 Request module 410, and the modem data service 404.

FIGS. 5B-5D are process flow diagrams of an example operations 500b-500d that may be performed as part of the method 500a performed by a processing system executing an IMS client in the UE in accordance with various embodiments. With reference to FIGS. 1-5D, means for performing the operations 500b-500d may include a processing system as described herein. A processing system may include one or more processors (e.g., 202, 212, 216, 218, 252, 428) of a UE (e.g., 120a-120e, 320, 402, 700), a modem coupled to a wireless transceiver (e.g., 266) providing a modem data service (e.g., 212, 252, 404), and/or hardware elements, any one or combination of which may be configured to perform any of the operations 500b-500d of the method 500a. Further, one or more processors within a processing system may be configured with software or firmware to perform various operations of the method. To encompass any of the processing system(s), hardware elements and software elements that may be involved in performing the operations 500b-500d, the elements performing method operations are referred to generally as a “processing system.”

Referring to FIG. 5B, in response to determining that the second network address to the PCSCF is available (i.e., determination block 504=“Yes”), the processing system may attempt to perform an initial registration with the second network address to the PCSCF in block 506 may include the operations in the method 500b in some embodiments.

At the same time as the operations in block 506 and the method 500b are being performed, the processing system may maintain the current IMS session with the network in block 510. For example, the processing system may avoid tearing down the session in response to an IPV6 NULL or IPv4 NULL message or indication. Maintaining the current IMS session enables completion of a fallback to the second network address to the PCSCF if that is possible.

In block 512, the processing system may create a second a handle for the alternative (“second”) network address for the PCSCF based on the address previously received when first negotiate but then dropped in favor of the first network address used to establish the current IMS connect to the network. For example, if the UE had received both and IPV4 and IPV6 address to the PCSCF initially, selected the IPV6 address and established the IMS session with the network using that type of service, and then received an IPV6 NULL message or indication, the processing system may create an IPV4 address in block 510. Alternatively, if the UE had received both and IPV4 and IPv6 address to the PCSCF initially, selected the IPv4 address and established the IMS session with the network using that type of service, and then received an IPV4 NULL message or indication, the processing system may create an IPV6 address in block 510.

In determination block 514, the processing system may query the network to determine whether the second network address for the PCSCF is valid. The operations in determination block 512 may involve the processing system executing the IMS client sending a message to the UE data service in the modem inquiring whether that address is available on the network, which may involve the data service sending a query message to the network using that address. A determination of whether the second address is valid may be based upon the response received from the network and/or the UV data service.

In response to determining that the second network address for the PCSCF is valid (i.e., determination block 514=“Yes”), the processing system may request a new connection to the network using the created second network address to the PCSCF in block 516. This may initiate handshaking communications with the PCSCF necessary to enable the current IMS session to continue using the second type of IP connection (i.e., IPv4 or IPv6).

In response to determining that the second network address for the PCSCF is not valid (i.e., determination block 514=“Yes”), the processing system may perform the operations in block 508 to tear down the IMS session and attempt to reestablish an IMS session according to conventional procedures as described.

Referring to FIG. 5C, following successfully registering with the network using the second network address to the PCSCF in either blocks 506 or 516, the processing system may release the connection to the network using the first network address to the PCSCF in block 520. Example, if the initial IMS session with the network was via an IPV6 address to the PCSCF and the UE has successfully registering with the network using an IPV4 address to the PCSCF, the processing system may release the connection that was using the IPV6 address. Similarly, if the initial IMS session with the network was via an IPV4 address to the PCSCF and the UE has successfully registered with the network using an IPV6 address to the PCSCF, the processing system may release the connection that was using the IPV4 address.

In block 522, the processing system may then continue the IMS session with the network using the second network address to the PCSCF.

Referring to FIG. 5D, in response to the processing system determining that there is no fallback available for continuing the IMS session (i.e., no valid second network address to the PCSCF), the processing system may attempt to establish and IMS connection to a data packet network (PDN) using at different (RAT), such as Wi-Fi, in block 530. In some embodiments, rather than waiting the 10 to 12 minutes before attempting to reestablish an IMS connection with the original network, the processing system may access different wireless communication capabilities of the UAE to determine whether there is another network available that can connect to an external PDN capable of continuing or establishing a new IMS communication session.

Operations of the various embodiments may be understood with reference to the example message flow diagrams illustrated in FIGS. 6A-6D. These diagrams illustrate operations of the embodiments in circumstances in which the UE has established an IPV6 communication link but falls back to an IPv4 communication link (FIG. 6A), the UE has established an IPV4 communication link but falls back to an IPV6 communication link (FIG. 6B), the UE has established an IPV6 communication link unsuccessfully attempts to fall back to an IPV4 communication link and then attempts to establish a network connection with a different RAT (FIG. 6C), and the UE has established an IPV4 communication link unsuccessfully attempts to fall back to an IPV6 communication link and then attempts to establish a network connection with a different RAT (FIG. 6D).

Referring to FIG. 6A, the IMS client in a UAE 408 may establish an IMS communication session by sending a request for IP addresses or IMS service to a network 142 (message 602a) via the modem data service 404 coupled to a wireless transceiver (e.g., 266) of the UE, which forwards the request 604a to the network. FIG. 6A illustrates a case in which the request for IP addresses to the PCSCF is in the form of a PDN V6V4 request 602a, which indicates that the UE has a preference for IPV6 over IPv4, such as based upon an operating system setting, application setting, user preference, or other type of setting. A network 142 capable of supporting both types of IP links may respond with a message 606 providing addresses to the PCSCF for both protocols (i.e., IPv4 and IPv6). This message may be received by the modem data service 404, which may complete the process of registering for a communication link with the network using the preferred (i.e., the IPV6 address to the PCSCF in the example illustrated in FIG. 6A), and inform the UE IMS client executing on the processing system that an IPV6 connection has been successfully established in message 608a. In response, the IMS client 408 may signal the modem data service 404 to release a communication link using IPv4, thereby establishing a successful IPv6 communication link 612a with the network.

Sometime thereafter, the network 142 may send a modified bearer message with a NULL IPV6 address 614a. This indicates that IMS service using the IPV6 protocol is no longer supported or available on the current network. As discussed above, this could occur for any number of reasons. In response to receiving such a message 614a, the modem data service 404 may forward this information in a message 616a to the IMS client 408. Since there is no current handle for an IPV4 link to the network, the IMS client may create and send to the modem data service 404 an IPV4 handle 618a, and then attempt to fetch an IPV4 address from the data service in message 620a. If that is successful, the UE IMS client 400 may send another PDN request for IP addresses or IMS service to the network 142, this time as a PDN V6V4 request 622a, which indicates that the UE has a preference for an IPv4 over IPv6 because IPv6 is not available. If this results in a successful connection to the network, the IMS client 408 may receive a message that the IPV4 connection was successful 624a, and in response informed the data service to release the IPV6 connection, and trigger a new IMS communication session 628a using the new IPv4 address to support continuing the current IMS communication session. Thus, even though the initial IPV6 communication link was dropped, the UE is able to continue an IMS communication with the network 142 without having to tear down the current communication link and go through the procedure for reestablishing a new IMS communication link to the network.

Referring to FIG. 6B, the illustrated process is similar except that the preferred communication link of the UE is IPV4 so the request for IMS service to the PCSCF, a PDN V4V6 request 602b, 604b is for an IPv4 (preferred) or IPv6 connection. The network 142 (namely the PCSCF) may provide addresses for both IP link types (message 606), and the modem data service 404 and UE IMS client 408 may establish an IPV4 communication link with the network 142 in messages 608b, 610b, 612b. Sometime thereafter, the network 142 may send a modified bearer message with a NULL IPv4 address 614b, indicating that IMS service using the IPv4 protocol is no longer supported or available on the current network. In response, the UE IMS client 408 and modem data service 404 may perform operations similar to those described with reference to FIG. 6A except to establish a new IMS link using an IPV6 address to the PCSCF in messages 616b, 618b, 620b, 622b, 624b, 626b, and 628b.

FIG. 6C illustrates a case that may happen when a fallback to an IPV4 address in an IMS session using the IPV6 protocol is unsuccessful because the IPV4 address is not valid. In this case, the messages exchanged among the UE IMS client 408, modem data service 404, and network 142 are the same as described with reference to FIG. 6A except that the network and data service report to the IMS 408 that the created IPv4 address is not valid or that a valid IPv4 address is not found (message 630a). In response, the processing system may throttle (e.g., put into an idle state) the radio that has been supporting the assignments communications (e.g., a 5G wireless transceiver and modem), and then use an alternate or different radio of a different RAT, such as Wi-Fi, to establish an IMS link to a network by sending another PDN V6V4 request over the alternative RAT in message 632a. In this manner, the UE may attempt to establish a communication link to continue the IMS session with a data network using another available wireless technology rather than wait 10 to 12 minutes before attempting reestablish an IMS session with the original wireless network.

FIG. 6D illustrates a similar situation as illustrated in FIG. 6C except that the initially preferred communication link of the UE is IPV4. Thus, the same messages as discussed with reference to FIG. 6B may be exchanged with the exception that the network and data service report to the IMS 408 that the created IPV6 address is not valid or that a valid IPv4 address is not found (message 630b). Similar to the case illustrated in FIG. 6C, the processing system may respond by throttling the radio that has been supporting the assignments communications (e.g., a 5G wireless transceiver and modem), and then use an alternate or different radio of a different RAT, such as Wi-Fi, to establish an IMS link to a network by sending another PDN V4V6 request over the alternative RAT in message 632b.

FIG. 7 is a component block diagram of a UE 700 suitable for use with various embodiments. With reference to FIGS. 1-7, various embodiments may be implemented on a variety of UEs 700 (for example, the UEs 120a-120e, 200, 320, 402), an example of which is illustrated in FIG. 7 in the form of a smartphone. The UE 700 may include a first SOC 202 (for example, a SOC-CPU) coupled to a second SOC 204 (for example, a 5G capable SOC). The first and second SOCs 202, 204 may be coupled to internal memory 716, a display 712, and to a speaker 714. Additionally, the UE 700 may include an antenna 704 for sending and receiving electromagnetic radiation that may be connected to a wireless transceiver 266 coupled to one or more processors in the first and/or second SOCs 202, 204. The UE 700 may include menu selection buttons or rocker switches 720 for receiving user inputs. The UE 700 may include a sound encoding/decoding (CODEC) circuit 710, which digitizes sound received from a microphone into data packets suitable for wireless transmission and decodes received sound data packets to generate analog signals that are provided to the speaker to generate sound. One or more of the processing systems in the first and second SOCs 202, 204, wireless transceiver 266 and CODEC 710 may include a digital signal processor (DSP) circuit (not shown separately).

The processors of the UE 700 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications. Software applications may be stored in the memory 716 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the method 500 may be substituted for or combined with one or more operations of the method 500.

Implementation examples are described in the following paragraphs. While some of the following implementation examples are described in terms of example methods, further example implementations may include: the example methods discussed in the following paragraphs implemented by a UE computing device including a wireless transceiver and a processor configured with processor-executable instructions to perform operations of the methods of the following implementation examples; the example methods discussed in the following paragraphs implemented by a UE computing device including means for performing functions of the methods of the following implementation examples; and the example methods discussed in the following paragraphs may be implemented as a non-transitory processor-readable storage medium having stored thereon processor-executable instructions configured to cause a processor of a UE computing device to perform the operations of the methods of the following implementation examples.

Example 1. A method performed by an Internet protocol (IP) multimedia service (IMS) client executing in a user equipment for managing a change in connection to a network during an IMS session with a network, including: determining whether a second network address for a Proxy Call Session Control Function (PCSCF) is available in response to receiving an indication that a first network address to the PCSCF is no longer available; attempting to perform an initial registration with the second network address to the PCSCF in response to determining that the second network address is available; and bringing down the IMS session with the network in response to determining that the second network address is not available.

Example 2. The method of example 1, in which: determining whether a second network address for the PCSCF is available includes: creating a second network address for the PCSCF; and querying the network whether the second network address for the PCSCF is valid; and attempting to perform an initial registration with the second network address to the PCSCF includes maintaining the IMS session with the network while requesting a new connection to the network using the created second network address to the PCSCF in response to receiving an indication the second network address for the PCSCF is valid.

Example 3. The method of example 2, further including: releasing the connection to the network using the first network address to the PCSCF in response to receiving an indication that the new connection to the network; and continuing the IMS session with the network using the second network address for the PCSCF.

Example 4. The method of any of examples 1-3, further including attempting to establish an IMS connection to a data packet network using a different radio access technology in response to failure of the attempt to perform an initial registration with the second network address to the PCSCF.

Example 5. The method of any of examples 1-4, in which the first network address to the PCSCF is an address for an IP version 6 (IPv6) address to the PCSCF and the second network address to the PCSCF is an IP version 4 (IPv4) address to the PCSCF.

Example 6. The method of any of examples 1-5, in which the first network address to the PCSCF is an address for an IP version 4 (IPv4) address to the PCSCF and the second network address to the PCSCF is an IP version 6 (IPv6) address to the PCSCF.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A computing device, comprising:
a wireless transceiver; and
a processor coupled to the memory and configured to:
determine whether a second network address for a Proxy Call Session Control Function (PCSCF) is available in response to receiving an indication that a first network address to the PCSCF is no longer available in an Internet protocol (IP) multimedia service (IMS) session;
attempt to perform an initial registration with the second network address to the PCSCF in response to determining that the second network address is available; and
bring down the IMS session with the network in response to determining that the second network address is not available.

2. The computing device of claim 1, wherein the processor is further configure to:
determine whether a second network address for the PCSCF is available by:
creating a second network address for the PCSCF; and
querying the network whether the second network address for the PCSCF is valid; and
attempt to perform an initial registration with the second network address to the PCSCF by maintaining the IMS session with the network while requesting a new connection to the network using the created second network address to the PCSCF in response to receiving an indication the second network address for the PCSCF is valid.

3. The computing device of claim 2, wherein the processor is further configure to:
release the connection to the network using the first network address to the PCSCF in response to receiving an indication that the new connection to the network; and
continue the IMS session with the network using the second network address for the PCSCF.

4. The computing device of claim 1, wherein the processor is further configure to attempt to establish an IMS connection to a data packet network using a different radio access technology in response to failure of the attempt to perform an initial registration with the second network address to the PCSCF.

5. The computing device of claim 1, wherein the first network address to the PCSCF is an address for an IP version 6 (IPv6) address to the PCSCF and the second network address to the PCSCF is an IP version 4 (IPv4) address to the PCSCF.

6. The computing device of claim 1, wherein the first network address to the PCSCF is an address for an IP version 4 (IPv4) address to the PCSCF and the second network address to the PCSCF is an IP version 6 (IPv6) address to the PCSCF.

7. A method performed by an Internet protocol (IP) multimedia service (IMS) client executing in a user equipment for managing a change in connection to a network during an IMS session with a network, comprising:
determining whether a second network address for a Proxy Call Session Control Function (PCSCF) is available in response to receiving an indication that a first network address to the PCSCF is no longer available;
attempting to perform an initial registration with the second network address to the PCSCF in response to determining that the second network address is available; and
bringing down the IMS session with the network in response to determining that the second network address is not available.

8. The method of claim 7, wherein:
determining whether a second network address for the PCSCF is available comprises:
creating a second network address for the PCSCF; and
querying the network whether the second network address for the PCSCF is valid; and
attempting to perform an initial registration with the second network address to the PCSCF comprises maintaining the IMS session with the network while requesting a new connection to the network using the created second network address to the PCSCF in response to receiving an indication the second network address for the PCSCF is valid.

9. The method of claim 8, further comprising:
releasing the connection to the network using the first network address to the PCSCF in response to receiving an indication that the new connection to the network; and
continuing the IMS session with the network using the second network address for the PCSCF.

10. The method of claim 7, further comprising attempting to establish an IMS connection to a data packet network using a different radio access technology in response to failure of the attempt to perform an initial registration with the second network address to the PCSCF.

11. The method of claim 7, wherein the first network address to the PCSCF is an address for an IP version 6 (IPv6) address to the PCSCF and the second network address to the PCSCF is an IP version 4 (IPv4) address to the PCSCF.

12. The method of claim 7, wherein the first network address to the PCSCF is an address for an IP version 4 (IPv4) address to the PCSCF and the second network address to the PCSCF is an IP version 6 (IPv6) address to the PCSCF.

13. A computing device, comprising:
means for determining whether a second network address for a Proxy Call Session Control Function (PCSCF) is available in response to receiving an indication that a first network address to the PCSCF is no longer available in an Internet protocol (IP) multimedia service (IMS) session;
means for attempting to perform an initial registration with the second network address to the PCSCF in response to determining that the second network address is available; and
means for bringing down the IMS session with the network in response to determining that the second network address is not available.

14. The computing device of claim 1, wherein:
means for determining whether a second network address for the PCSCF is available comprises:
means for creating a second network address for the PCSCF; and
means for querying the network whether the second network address for the PCSCF is valid; and
means for attempting to perform an initial registration with the second network address to the PCSCF comprises means for maintaining the IMS session with the network while requesting a new connection to the network using the created second network address to the PCSCF in response to receiving an indication the second network address for the PCSCF is valid.

15. The computing device of claim 14, further comprising:
means for releasing the connection to the network using the first network address to the PCSCF in response to receiving an indication that the new connection to the network; and
means for continuing the IMS session with the network using the second network address for the PCSCF.

16. The computing device of claim 1, further comprising means for attempting to establish an IMS connection to a data packet network using a different radio access technology in response to failure of the attempt to perform an initial registration with the second network address to the PCSCF.

17. The computing device of claim 1, wherein the first network address to the PCSCF is an address for an IP version 6 (IPv6) address to the PCSCF and the second network address to the PCSCF is an IP version 4 (IPv4) address to the PCSCF.

18. The computing device of claim 1, wherein the first network address to the PCSCF is an address for an IP version 4 (IPv4) address to the PCSCF and the second network address to the PCSCF is an IP version 6 (IPv6) address to the PCSCF.

19. A non-transitory processor-readable medium having stored thereon processor-executable instructions configured to cause a processing system of a computing device to perform operations comprising:
determining whether a second network address for a Proxy Call Session Control Function (PCSCF) is available in response to receiving an indication that a first network address to the PCSCF is no longer available in an Internet protocol (IP) multimedia service (IMS) session;
attempting to perform an initial registration with the second network address to the PCSCF in response to determining that the second network address is available; and
bringing down the IMS session with the network in response to determining that the second network address is not available.

20. The non-transitory processor-readable medium of claim 19, wherein the stored processor-readable instructions are further configured to cause a processor of a computing device to perform operations such that:
determining whether a second network address for the PCSCF is available comprises:
creating a second network address for the PCSCF; and
querying the network whether the second network address for the PCSCF is valid; and
attempting to perform an initial registration with the second network address to the PCSCF comprises maintaining the IMS session with the network while requesting a new connection to the network using the created second network address to the PCSCF in response to receiving an indication the second network address for the PCSCF is valid.

21. The non-transitory processor-readable medium of claim 20, wherein the stored processor-readable instructions are further configured to cause a processor of a computing device to perform operations further comprising:
releasing the connection to the network using the first network address to the PCSCF in response to receiving an indication that the new connection to the network; and
continuing the IMS session with the network using the second network address for the PCSCF.

22. The non-transitory processor-readable medium of claim 19, wherein the stored processor-readable instructions are further configured to cause a processor of a computing device to perform operations further comprising attempting to establish an IMS connection to a data packet network using a different radio access technology in response to failure of the attempt to perform an initial registration with the second network address to the PCSCF.

23. The non-transitory processor-readable medium of claim 19, wherein the first network address to the PCSCF is an address for an IP version 6 (IPv6) address to the PCSCF and the second network address to the PCSCF is an IP version 4 (IPv4) address to the PCSCF.

24. The non-transitory processor-readable medium of claim 19, wherein the first network address to the PCSCF is an address for an IP version 4 (IPv4) address to the PCSCF and the second network address to the PCSCF is an IP version 6 (IPv6) address to the PCSCF.
